(19) United States
(12) Patent Application Publication
(10) Pub. No.: US 2015/0045167 A1
(43) Pub. Date: Feb. 12, 2015

(54) HYDRAULIC POWER TRAIN FOR HYBRID VEHICLE

(71) Applicant: Hyundai Motor Company, Seoul (KR)

(72) Inventors: Kyung S. Lee, Seocho-gu (KR); Tal Chol Kim, Incheon (KR); Sung Tae Cho, Gyeonggi-do (KR); Sang J. Lee, Gyeonggi-do (KR)

(73) Assignee: HYUNDAI MOTOR COMPANY, Seoul (KR)

(21) Appl. No.: 14/104,161

(22) Filed: Dec. 12, 2013

(30) Foreign Application Priority Data
Aug. 9, 2013 (KR) 10-2013-0094608

(51) Int. Cl. F16H 47/04

(52) U.S. Cl. CPC F16H 47/04
USPC 475/72

(57) ABSTRACT

A hydraulic power train for a hybrid vehicle is provided, which can selectively transmit power of a hydraulic driving unit or an engine to driving wheels using a double pinion planetary gear and a synchro sleeve in addition to the hydraulic driving unit. More specifically, a hydraulic power train for a hybrid vehicle is provided, which can achieve various driving modes and maximize the fuel efficiency, by combining a hydraulic driving unit, a double pinion planetary gear, and a synchro-type transmission to implement a continuously variable transmission for a hybrid vehicle that can selectively transmit power of an engine or a hydraulic driving unit.

### CROSS-REFERENCE TO RELATED APPLICATION

This application claims under 35 U.S.C. §119(a) the benefit of Korean Patent Application No. 10-2013-0094608 filed Aug. 9, 2013, the entire contents of which are incorporated herein by reference.

### BACKGROUND

(a) Technical Field

The present invention relates to a hydraulic power train for a hybrid vehicle. More particularly, the present invention relates to a hydraulic power train for a hybrid vehicle, which can selectively transmit power of a hydraulic driving unit or an engine to drive wheels using a double pinion planetary gear and a synchro sleeve in addition to the hydraulic driving unit.

(b) Background Art

Recently, vehicle manufacturers are leaning towards improvement in fuel efficiency and eco-friendliness of a vehicle as core goals and development objectives due to high oil prices and regulations on carbon dioxide emissions. Vehicle manufacturers have been endeavoring to develop a technology for fuel reduction in order to achieve the above goals and objectives. As a result, vehicle manufacturers are focusing on the improvement of the eco-friendly image and technical skills by mass-producing eco-friendly vehicles like pure electric vehicles, hybrid and plug-in hybrid vehicles, and fuel cell vehicles.

Hybrid vehicles among these types of eco-friendly vehicles can promote the reduction of exhaust gas and the improvement of fuel efficiency by utilizing a motor as well as an engine as a power source. Hybrid vehicles requires a transmission system having high efficiency and performance power in order to transmit the engine's power or the motor's power separately or simultaneously to the drive wheels.

As shown in FIG. 1, a typical power train for a hybrid vehicle includes an engine 1 and a motor 2 that are directly connected to each other, a clutch 3 that is arranged between the engine 1 and the motor 2 to transmit or interrupt the engine's power, a transmission 4 that changes the speed of the power to output the power to a drive wheel 6, and a generator 5 that is connected to a crank pulley of the engine to start the engine and generate electricity.

The driving modes of the hybrid vehicles including the power train include Electric Vehicle (EV) mode, i.e., pure electric vehicle mode that uses only the motor's power, Hybrid Electric Vehicle (HEV) mode that uses the engine as a main power source and the motor as an auxiliary power source, and the Regenerative Braking (RB) mode that recovers vehicle's braking or the inertial energy through the electricity generation in the motor during the braking of a vehicle or the inertia driving of a vehicle and charges electricity to the battery.

The power train for the hybrid vehicle as described above can secure a driving force using the motor instead of the engine and promotes the improvement of fuel efficiency in a driving condition where a cruise driving or a small output are required. On the other hand, in a driving condition where a large output is required, the power train for the hybrid vehicle can significantly increase the fuel efficiency compared to internal-combustion engine vehicle, by operating the engine at a highly-efficient operating point and allowing the motor to be driven for a deficient output or generate electricity via an excessive output.

However, in terms of the extension of the driving performance of the plug-in hybrid vehicles, there is a limitation in that when the driving force of the motor is significantly required, since the specifications of the motor system have to be continuously enlarged. Thus, the development of a high efficiency and performance driving power transmission system for a hybrid vehicle is required to prepare for the era of eco-friendly vehicles.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention provides a hydraulic power train for a hybrid vehicle, which can achieve various driving modes and maximize the fuel efficiency, by combining a hydraulic driving unit, a double pinion planetary gear, and a synchro-type transmission to implement a Continuously Variable Transmission (CVT) for a hybrid vehicle that can selectively transmit power of an engine or a hydraulic driving unit.

In one aspect, the present invention provides a hydraulic power train for a hybrid vehicle, comprising: a double pinion planetary gear set; an engine power-transmittably connected to one of operation components of the double pinion planetary gear set; a first hydraulic driving unit power-transmittably connected to another of the operation components of the double pinion planetary gear set; a second hydraulic driving unit power-transmittably connected to the other of the operation components of the double pinion planetary gear set; a hydraulic supply unit hydraulic-suppliably connected to the first hydraulic driving unit and the second hydraulic driving unit; an output gear set connected to output shafts of the operation components of the double pinion planetary gear set connected to the engine and the first hydraulic driving unit to deliver power to a drive wheel; and a power intermittence unit mounted on the output shaft of the operation component of the double pinion planetary gear set connected to the engine to control engine power.

In an exemplary embodiment, the engine may include an output shaft connected to a ring gear among the operation components of the double pinion planetary gear set.

In another exemplary embodiment, the first hydraulic driving unit may include an output shaft connected to a planetary carrier gear among the operation components of the double pinion planetary gear set.

In still another exemplary embodiment, the second hydraulic driving unit may include an output shaft connected to a sun gear among the operation components of the double pinion planetary gear set.

In yet another exemplary embodiment, the first hydraulic driving unit and the second hydraulic driving unit may include a hydraulic motor or a hydraulic pump.

In still yet another exemplary embodiment, the hydraulic supply unit may include a high-pressure accumulator storing hydraulic energy or supplying hydraulic energy to the first and second hydraulic driving unit and a low-pressure reservoir connected to a discharge line of the high-pressure accumulator. The high-pressure accumulator may include a gas chamber that is disposed at the innermost side of the high-pressure accumulator to store gas so that gas is compressed, an oil chamber that is disposed at the outermost side of the high-pressure accumulator to store oil so that oil flows in and out thereof, and a piston that is disposed between the gas chamber and the oil chamber to move toward the oil chamber when gas is expanded or move toward the gas chamber when oil is compressed.

In another further exemplary embodiment, the output gear set may include: a first output gear disposed at an output shaft of a ring gear connected to the engine among the operation components of the double pinion planetary gear set to rotate or stop rotating according to a power permission or interruption of the power intermittence unit; a second output gear connected to an output shaft of the planetary carrier gear connected to the first hydraulic driving unit among the operation components of the double pinion planetary gear set and simultaneously engaged with the first output gear; and a plurality of reduction gears decelerating a power of the second output gear to deliver the power to the drive wheel.

In still another further exemplary embodiment, the power intermittence unit may be connected to the output shaft of the ring gear connected to the engine to deliver a rotatory power of the ring gear to the first output gear when moving closely to the first output gear or interrupt the rotatory power of the ring gear to the first output gear when moving away from the first output gear.

In yet another further exemplary embodiment, upon entering Hybrid Electric Vehicle (HEV) driving mode in which the engine, the first hydraulic driving unit, and the second hydraulic driving unit are simultaneously driven, power according to an operation of the first hydraulic driving unit may be utilized as auxiliary power that is joined with power of the engine to be outputted to the drive wheels, and the second hydraulic driving unit may serve to control an engine operating point while receiving the power of the engine through a sun gear of the double pinion planetary gear set.

Other aspects and exemplary embodiments of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a view illustrating an exemplary power transmission system for a hybrid vehicle;

FIG. 2 is a view illustrating a hydraulic power train for a hybrid vehicle according to an exemplary embodiment of the present invention;

FIGS. 3 to 7 are views illustrating power transmission paths for each operation mode of a hydraulic power train for a hybrid vehicle according to an exemplary embodiment of the present invention;

FIG. 8 is a view illustrating the internal structure of an accumulator of a hydraulic power train for a hybrid vehicle according to an exemplary embodiment of the present invention; and

FIG. 9 is a view illustrating the operation principle of a synchro sleeve adopted as a power intermittence unit of a hydraulic power train for a hybrid vehicle according to an exemplary embodiment of the present invention.

Reference numerals set forth in the Drawings includes reference to the following elements as further discussed below:

| | | | |
|---|---|---|---|
| 10: | double pinion planetary gear set | 12: | ring gear |
| 14: | planetary carrier gear | 16: | sun gear |
| 20: | engine | 30: | first hydraulic driving unit/pump |
| 40: | second hydraulic driving unit/ | 50: | hydraulic supply unit |
| | pump | 54: | low-pressure reservoir |
| 52: | high-pressure accumulator | 56: | oil chamber |
| 55: | gas chamber | 60: | power intermittence unit |
| 58: | piston | 72: | first output gear |
| 70: | output gear set | 76: | reduction gear |
| 74: | second output gear | | |
| 80: | drive wheel | | |

It should be understood that the accompanying drawings are not necessarily to scale, presenting a somewhat simplified representation of various exemplary features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The above and other features of the invention are discussed infra.

Hereinafter, exemplary embodiments of the present invention will be described in detail with reference to the accompanying drawings so that those skilled in the art can easily carry out the present invention.

Hereinafter, exemplary embodiments of the present invention will be described in detail with reference to the accompanying drawings.

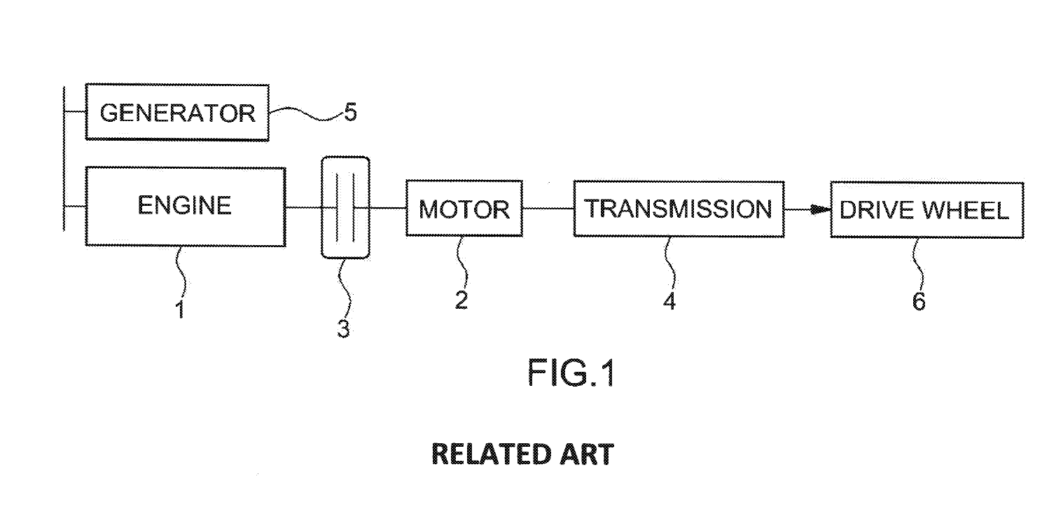

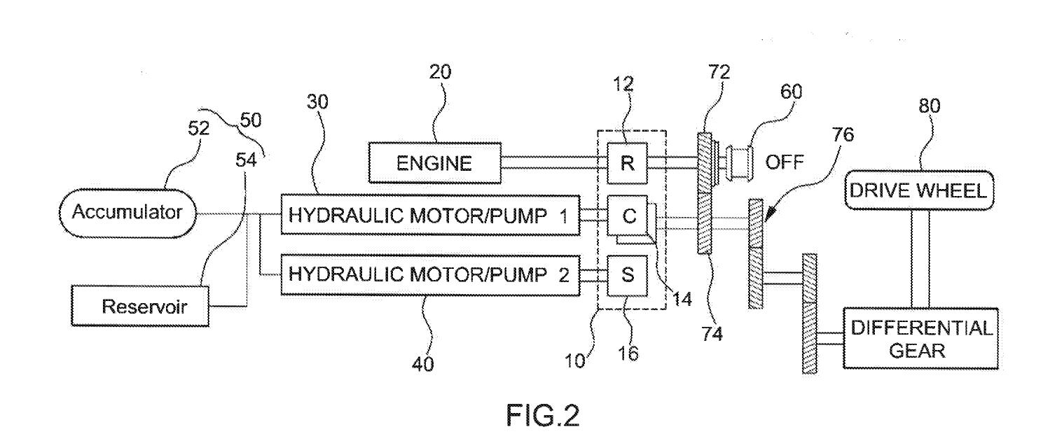

Referring to FIG. 1, a hydraulic power train for a hybrid vehicle according to an exemplary embodiment of the present invention relates to a hydraulic continuously variable transmission that transmits power of a hydraulic driving unit in addition to power of an engine to drive wheels. The hydraulic power train may include a first hydraulic driving unit 30 and a second hydraulic driving unit 40 that are driven by a hydraulic supply unit 50 in addition to an engine 20.

The first hydraulic driving unit 30 may provide a driving power when a vehicle is operating, and may charge a hydraulic pressure into the hydraulic supply unit during the regenerative braking. Also, the first hydraulic driving unit 30 may be provided to assist the engine power, and preferably, may include a hydraulic motor or a hydraulic pump.

The second hydraulic driving unit 40 may receive certain power from the engine to control the engine operating point, and may charge a hydraulic pressure into an actuator of the hydraulic supply unit. Also, the second hydraulic driving unit 40 may serve to start the engine, and may include a hydraulic motor or a hydraulic pump.

The output shaft of the first and second hydraulic driving units 30 and 40 as well as the engine 20 may be power-transmissively connected to each component of the double pinion planetary gear set 10 that performs power-split.

More specifically, the output shaft of the engine may be connected to a ring gear 12 among the actuating components of the double pinion planetary gear set 10. The output shaft of the first hydraulic driving unit 30 may be connected to a planetary carrier gear 14 among the actuating components of the double pinion planetary gear set 10, and the output shaft of the first hydraulic driving unit 30 may be power-transmissively connected to a sun gear 16 among the actuating components of the double pinion planetary gear set 10. In this case, the planetary carrier gear 14 may be disposed in pairs between the sun gear 16 and the ring gear 12 to rotatably support pinions that are arranged in a circumferential direction at a uniform interval.

The hydraulic supply unit 50 may be connected to the first hydraulic driving unit 30 and the second hydraulic driving unit 40. The hydraulic supply unit 50 may include a high-pressure accumulator 52 that stores hydraulic energy or supplies hydraulic energy to the first and second hydraulic driving units 30 and 40 and a low pressure reservoir 54 connected to a discharge line of the high-pressure accumulator 52 in order to store surplus fluid for hydraulic supply.

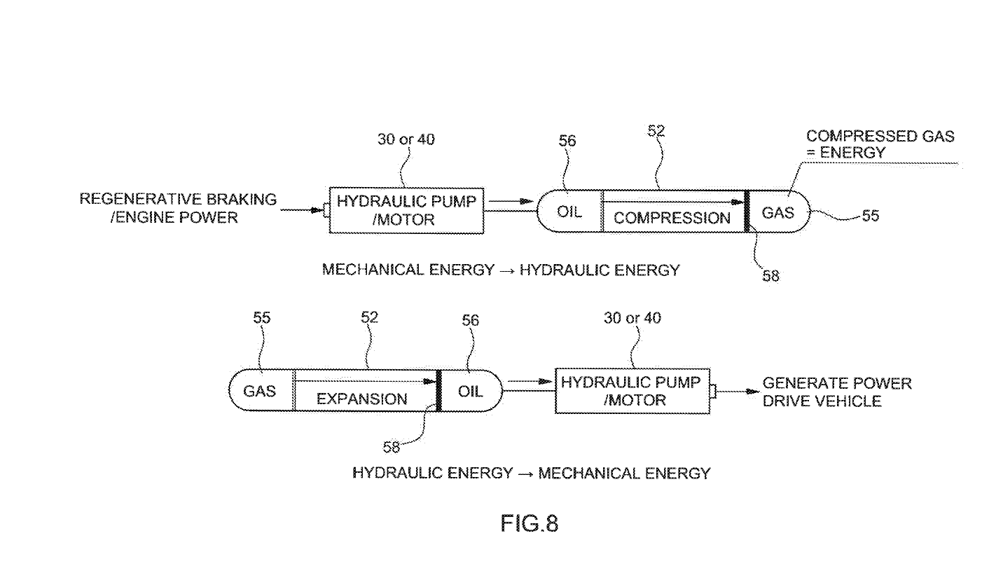

The inside of the high-pressure accumulator 52 of the hydraulic supply unit 50, as shown in FIG. 8, may be divided into a gas chamber 54 that is disposed at the innermost side and stores compressed gas, and an oil chamber 56 that is disposed at the outermost side and stores oil such that oil can flow in and out thereof. A piston 58 may be disposed between the gas chamber 54 and the oil chamber 56.

Accordingly, when the gas chamber 54 expands, the piston 58 may move toward the oil chamber 56 due to the gas pressure, and the hydraulic oil of the oil chamber 56 may be supplied to the first and second hydraulic driving units 30 and 40. Continuously, the hydraulic motor and the hydraulic pump adopted as the first and the second hydraulic driving units 30 and 40 may operate in unison, generating power for the driving of a vehicle.

On the other hand, when regenerative braking or engine power are reversely inputted into the first and second driving units 30 and 40, hydraulic oil that drives the hydraulic motor and the hydraulic pump may quickly return to the oil chamber 56, and simultaneously, oil inside the oil chamber 56 may be compressed. In this case, due to the compressed pressure of oil, the piston 58 may be moved toward the gas chamber, compressing gas inside the gas chamber 54. Thus, compressed gas inside the gas chamber 54 may hold expandable energy as well.

Meanwhile, an output gear set that transmits power to the drive wheels 80 may be connected to the output shafts of the planetary carrier gear 14 connected to the first hydraulic driving unit 30 and the ring gear 12 connected to the engine 20 respectively among the actuating factors of the double pinion planetary gear set 10.

More specifically, the output gear set may include a first output gear 72, and a second output gear 74, and a plurality of reduction gears 76. The first output gear 72 may be connected to the output shaft of the ring gear 12 connected to the engine 20 among the operation components of the double pinion planetary gear set 10 to rotate or stop rotating according to the power permission or interruption of the power intermittence unit 60. The second output gear 74 may be connected to the output shaft of the planetary carrier gear 14 connected to the first hydraulic driving unit 30 among the operation components of the double pinion planetary gear set 10, and simultaneously may be engaged with the first output gear 72. The plurality of reduction gears 76 may decelerate the power of the second output gear 74 to deliver the power to the drive wheel 80.

The power intermittence unit 60 may be mounted on the output shaft of the ring gear 12 of the double pinion planetary gear set 10 connected to the engine 20 to rotate together with the driving of the engine, and may include a typical synchro sleeve having a structure horizontally transferable according to the input manipulation.

That is, the synchro sleeve operating as the power intermittence unit 60 may be connected to the output shaft of the ring gear 12 connected to the engine 20 to deliver the rotatory power of the ring gear 12 to the first output gear 72 when moving closely to the first output gear 72 according to the input manipulation or interrupt the rotatory power of the ring gear 12 to the first output gear 72 when moving away from the first output gear 72.

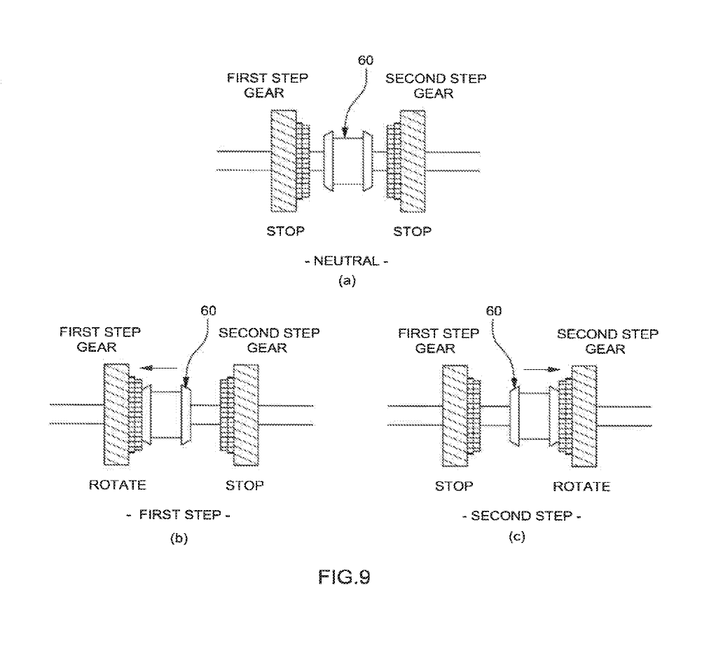

Referring to FIG. 9, the operation principle of the synchro sleeve is shown. The synchro sleeve may be horizontally transferably mounted on the rotation driving shaft, and a first step gear and a second step gear may be disposed across the synchro sleeve. When the synchro sleeve moves closely to the first step gear according to the input manipulation, the power of the rotation driving shaft may be delivered to the first step gear. On the other hand, when the synchro sleeve moves closely to the second step gear according to the input manipulation, the power of the rotation driving shaft may be delivered to the second step gear.

Meanwhile, a separate solenoid valve may be added to a hydraulic line between the accumulator and the first and second hydraulic driving units to control the flow of hydraulic oil by opening and closing in accordance with the operation timing for each driving mode.

Hereinafter, the operation modes of a hydraulic power train for a hybrid vehicle according to an embodiment of the present invention will be described in detail.

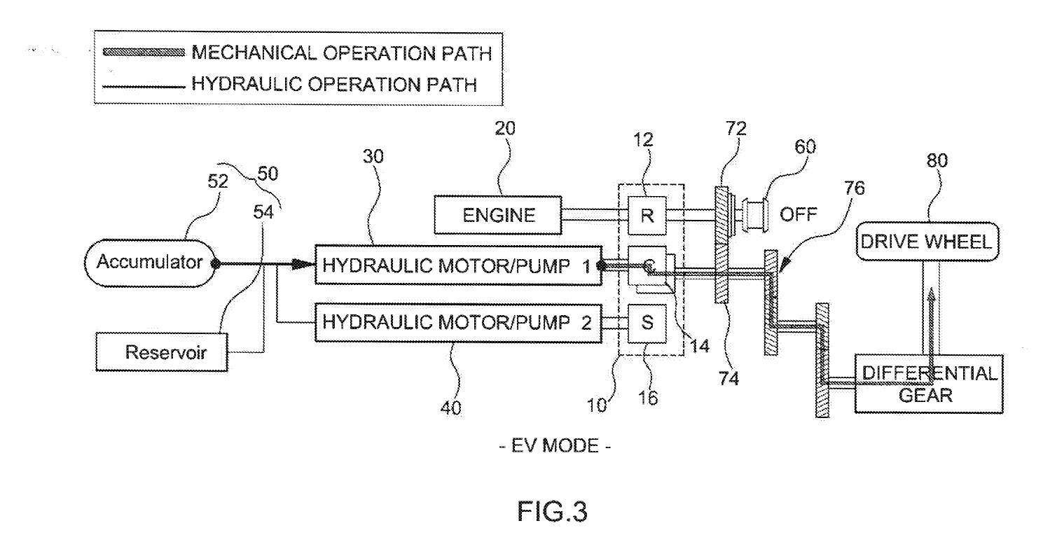

Electric Vehicle (EV) Mode (See FIG. 3)

EV mode denotes a driving mode for delivering a driving force of a hydraulic motor or a pump used as the first hydraulic driving unit 30 to drive the wheels. First, when compressed gas inside the gas chamber 54 of the accumulator 52 holds expandable energy, a piston 58 may move toward the oil chamber 56 due to a gas pressure during the expansion of gas, and hydraulic oil inside the oil chamber 56 may be supplied to the hydraulic motor or the hydraulic pump used within the first hydraulic driving unit 30.

Thereafter, the rotatory power according to the operation of the first hydraulic driving unit 30 may be delivered to the input side of the planetary carrier gear 14 of the double pinion planetary gear set 10, and then may be delivered to the output side of the planetary carrier gear 14.

For example, input-side pinions supported by the planetary carrier gear 14 at the input side may revolve on the axis thereof along the ring gear 12, and simultaneously, output-side pinions may revolve around the sun gear 16. Thus, the output side planetary carrier gear 14 supporting the output-side pinions may rotate.

Then, power delivered to the output-side planetary carrier gear 14 may be outputted to the second output gear connected to the output shaft of the output-side planetary carrier gear 14, and then may be outputted to the drive wheels 80 through the reduction gear 76, enabling the initial low-speed driving of a vehicle.

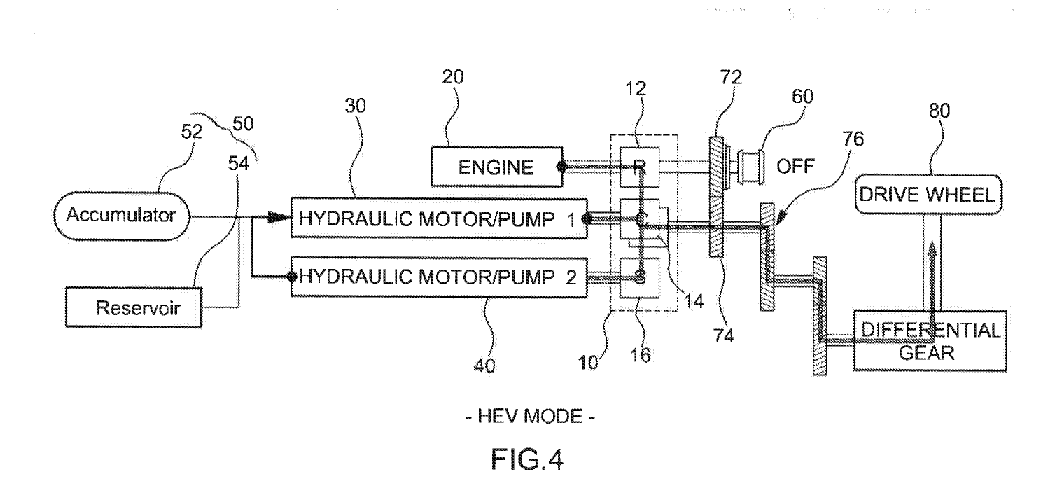

Hybrid Electric Vehicle (HEV) Mode (See FIG. 4)

In EV mode described above, the engine may be driven, and thus the power of the engine may be delivered to the ring gear 12, allowing the sun gear 16 to rotate in the same direction as the ring gear 12 due to a continuous engaging movement of the double pinion supported by the planetary carrier gear 14.

In this case, the rotating force of the ring gear 12, that is, the engine power may be added to the power of the planetary carrier gear 14, and thus the power of the first hydraulic driving unit 30 and the engine may be joined to be outputted to the second output gear 74 and then outputted to the drive wheels 80 through the reduction gear 76, enabling the medium-speed driving of a vehicle.

In this case, the rotational force of the double pinion supported by the planetary carrier gear 14 may be delivered to the second hydraulic driving unit 40 through the sun gear 16, allowing the hydraulic motor or pump used as the second driving unit 40 to be driven in reverse and thus serving to control the engine operating point. Also, the hydraulic pressure of the second hydraulic driving unit 40 may be supplied to the first hydraulic driving unit 30.

Upon entering HEV driving mode, since the engine 20, the first hydraulic driving unit 30, and the second hydraulic driving unit 40 are simultaneously driven, power according to the operation of the first hydraulic driving unit 30 may be utilized as auxiliary power that is joined with the power of the engine 20 to be outputted to the drive wheels. Also, the second hydraulic driving unit 40 that operates while receiving the engine power through the sun gear 16 of the double pinion planetary gear set 10 may serve to control the engine operating point.

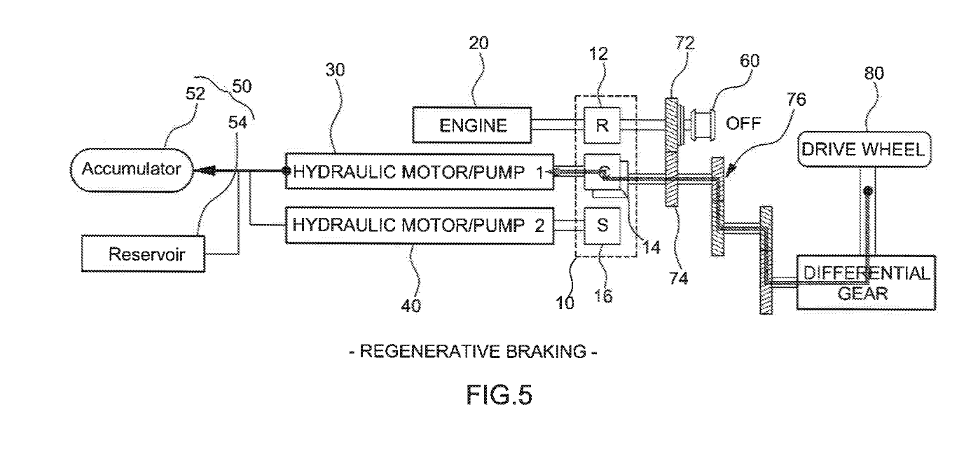

Regenerative Braking (RB) Mode (See FIG. 5)

Regenerative braking mode denotes operation mode in which upon braking during the driving of a vehicle, a counter torque is sequentially applied to the drive wheel, the reduction gear 76, the second output gear 74, and the planetary carrier 14 to charge gas and hydraulic pressure to the accumulator 52.

Accordingly, when the torque according to the regenerative braking is reversely inputted into the first hydraulic driving unit 30, hydraulic oil applied to the first hydraulic driving unit 30 may quickly return to the oil chamber 56 of the accumulator 52 to be compressively charged, and simultaneously, the piston 58 may move toward the gas chamber 54 by the compressive force of oil, compressing gas inside the gas chamber 54. Thus, the compressed gas inside the gas chamber 54 may again hold expandable energy.

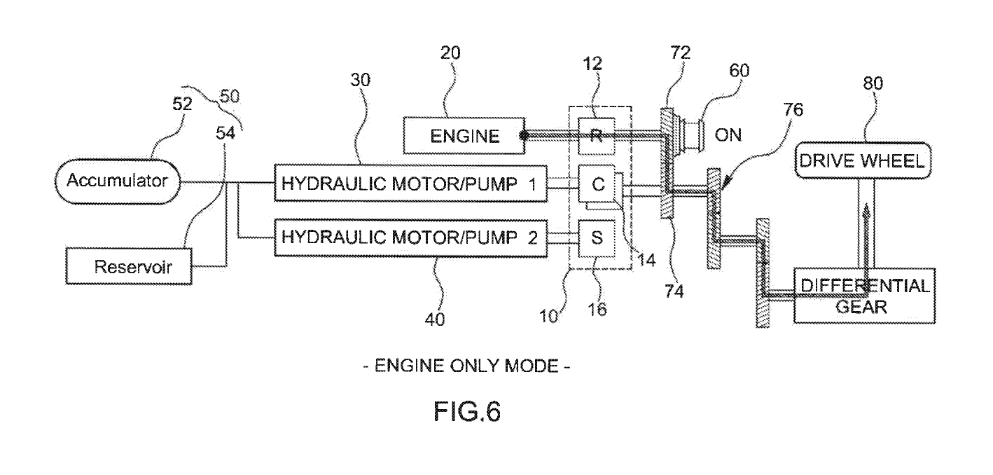

Engine Only Mode (See FIG. 6)

When hydraulic pressure supplied from the accumulator 52 to the first and second hydraulic driving units 30 and 40 is released to stop operating the first and second hydraulic driving units 30 and 40, only the engine 20 may be driven. Under these conditions, the synchro sleeve that is used as the power intermittence unit 60 may be adhered closely to the first output gear 72 that is arranged on the same axis as the output shaft of the ring gear 12 according to the input manipulation. Thus, a power transmittable state can be achieved.

Accordingly, the engine power may be outputted to the drive wheels 80 through the ring gear 12, the first output gear 72, and the reduction gear 76, enabling the high-speed driving of a vehicle.

In this case, the rotatory power of the ring gear 12 can be delivered to the first hydraulic driving unit 30 through the planetary carrier gear 14. The delivered power may be utilized as power for charging hydraulic pressure into the accumulator 52.

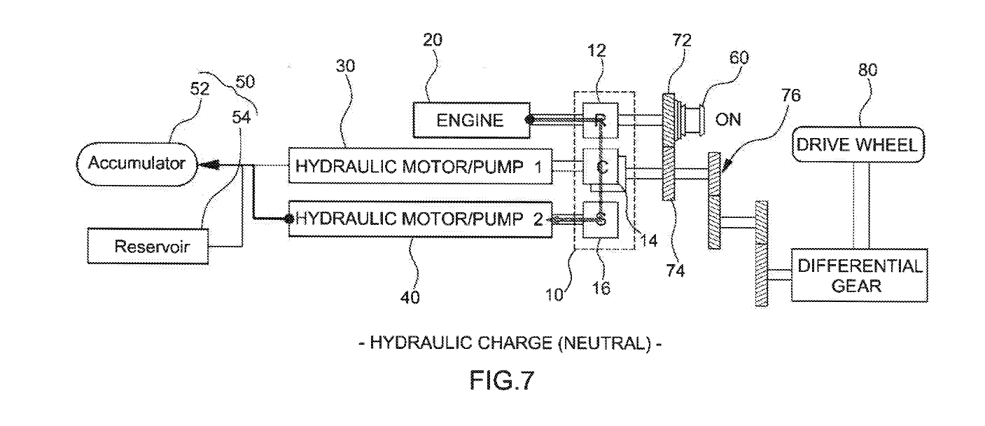

Hydraulic Charge Mode (see FIG. 7)

Hydraulic charge mode in the illustrative embodiment of the present invention may be performed in Neutral mode, not in a Drive mode. When a transmission lever is located in Neutral, the hydraulic pressure may be released to stop the first hydraulic driving unit 30, and then the engine 20 may be operated.

Accordingly, the rotatory power of the ring gear 12, i.e., engine power may be delivered to the sun gear 16 through the double pinion supported by the planetary carrier gear 14, and simultaneously, may be delivered to the second hydraulic driving unit 40. Thus, the hydraulic motor or pump that is used as the second hydraulic driving unit 40 may be driven in reverse, compressively charging hydraulic oil that is being applied to the first and second hydraulic driving unit 30 and 40 into the oil chamber 56 of the accumulator 52.

Simultaneously, the piston 58 may move to the gas chamber 54 by the compressive force of oil, compressing gas inside the gas chamber 54. Thus, the compressed gas inside the gas chamber 54 may hold expandable energy.

The present invention provides the following effects.

According to an exemplary embodiment of the present invention, a high efficiency and performance power transmission system that can implement various driving modes and maximize the fuel efficiency is provided by combining a hydraulic driving unit, a double pinion planetary gear, and synchro-type transmission without increasing the specifications of a motor system in consideration of the extension of the driving performance of a typical hybrid vehicle to implement a Continuously Variable Transmission (CVT) for a hybrid vehicle that can selectively deliver power of an engine or the hydraulic driving unit to a drive wheel.

Particularly, since a hydraulic power splitting system acts as a CVT, a power train according to an exemplary embodiment of the present invention enables the operation of the engine at an optimal operating point, and thus can achieve the improvements in the fuel efficiency.

Also, since the limitations of the power splitting system is supplemented by increasing the efficiency using engine only mode at a high vehicle speed in order to prevent the rapid reduction of the efficiency due to the power recycling phenomenon of the hydraulic power splitting system during the high-speed driving, additional improvements in the fuel efficiency can be expected.

Furthermore, a typical electric hybrid requires various kinds of expensive parts such batteries and inverters, whereas the hydraulic power transmission system of the present invention is relatively cheap in terms of the price of each component, thereby providing excellent price compared to a typical hybrid type.

The invention has been described in detail with reference to exemplary embodiments thereof. However, it will be appreciated by those skilled in the art that changes may be made in these embodiments without departing from the principles and spirit of the invention, the scope of which is defined in the appended claims and their equivalents.

What is claimed is:

1. A hydraulic power train for a hybrid vehicle, comprising:
a double pinion planetary gear set;
an engine power-transmittably connected to one of operation components of the double pinion planetary gear set;
a first hydraulic driving unit power-transmittably connected to another of the operation components of the double pinion planetary gear set;
a second hydraulic driving unit power-transmittably connected to a remaining other of the operation components of the double pinion planetary gear set;
a hydraulic supply unit hydraulic-suppliably connected to the first hydraulic driving unit and the second hydraulic driving unit;
an output gear set connected to output shafts of the operation components of the double pinion planetary gear set connected to the engine and the first hydraulic driving unit to deliver power to a drive wheel; and
a power intermittence unit mounted on the output shaft of the operation component of the double pinion planetary gear set connected to the engine to control engine power.

2. The hydraulic power train of claim 1, wherein the engine comprises an output shaft connected to a ring gear among the operation components of the double pinion planetary gear set.

3. The hydraulic power train of claim 1, wherein the first hydraulic driving unit comprises an output shaft connected to a planetary carrier gear among the operation components of the double pinion planetary gear set.

4. The hydraulic power train of claim 1, wherein the second hydraulic driving unit comprises an output shaft connected to a sun gear among the operation components of the double pinion planetary gear set.

5. The hydraulic power train of claim 1, wherein the first hydraulic driving unit and the second hydraulic driving unit comprise a hydraulic motor or a hydraulic pump.

6. The hydraulic power train of claim 1, wherein the hydraulic supply unit comprises an accumulator storing hydraulic energy or supplying hydraulic energy to the first and second hydraulic driving unit and a reservoir connected to a discharge line of the accumulator.

7. The hydraulic power train of claim 6, wherein the accumulator comprises a gas chamber that is disposed at the innermost side of the accumulator to store gas so that gas is compressed, an oil chamber that is disposed at the outermost side of the accumulator to store oil so that oil flows in and out thereof, and a piston that is disposed between the gas chamber and the oil chamber to move toward the oil chamber when gas is expanded or move toward the gas chamber when oil is compressed.

8. The hydraulic power train of claim 1, wherein the output gear set comprises:
a first output gear disposed at an output shaft of a ring gear connected to the engine among the operation components of the double pinion planetary gear set to rotate or stop rotating according to a power permission or interruption of the power intermittence unit;
a second output gear connected to an output shaft of a planetary carrier gear connected to the first hydraulic driving unit among the operation components of the double pinion planetary gear set and simultaneously engaged with the first output gear; and
a plurality of reduction gears decelerating a power of the second output gear to deliver the power to the drive wheel.

9. The hydraulic power train of claim 8, wherein the power intermittence unit is connected to the output shaft of the ring gear connected to the engine to deliver a rotatory power of the ring gear to the first output gear when moving closely to the first output gear or interrupt the rotatory power of the ring gear to the first output gear when moving away from the first output gear.

10. The hydraulic power train of claim 8, wherein upon entering a Hybrid Electric Vehicle (HEV) driving mode in which the engine, the first hydraulic driving unit, and the second hydraulic driving unit are simultaneously driven, power according to an operation of the first hydraulic driving unit is utilized as auxiliary power that is joined with power of the engine to be outputted to the drive wheels, and the second hydraulic driving unit serves to control an engine operating point while receiving the power of the engine through a sun gear of the double pinion planetary gear set.
